(19) United States
(12) Patent Application Publication
(10) Pub. No.: US 2002/0182044 A1
(43) Pub. Date: Dec. 5, 2002

(54) Central monitoring and control station for a garbage truck

(76) Inventor: Jui-Wen Yu, Taipei (TW)

Correspondence Address: Hedman & Costigan, P.C., 1185 Avenue of the Americas, New York, NY, 10036-2646, US

(21) Appl. No.: 09/866,935

(22) Filed: May 29, 2001

(51) Int. Cl. B65F 3/00

(52) U.S. Cl. 414/525.1

(57) ABSTRACT

A central monitoring and control station for a garbage truck has a panel, multiple switches, multiple monitoring units and multiple sensors. The multiple switches are mounted on the panel, and each is connected to one of the cylinders on the garbage truck. The monitoring units are mounted on the panel, and each monitoring unit electrically connects to at least one sensor. Each sensor is mounted on the garbage truck and corresponds to one of the cylinders on the garbage truck. With such a central monitoring and control station, the position of the piston rod of each cylinder on the garbage truck is detected and shown. The user can find a damaged device immediately. To repair the damaged device on the garbage truck becomes more efficient.

### BACKGROUND OF THE INVENTION

1. Field of the Invention

The present invention relates to a monitoring and control station, and more particularly to a central monitoring and control station for monitoring and controlling the motions of a garbage scoop, a lock device, a tailgate actuator, a dumping actuator or a trailer hitch assembly to connect a trailer to a garbage truck.

2. Description of Related Art

With reference to FIGS. 2 to 4, a garbage truck always has a garbage compactor (20) pivotally mounted on a garbage compartment (10) to close the open end of the garbage compartment (10). A garbage scoop (34) is mounted in the garbage compactor (20) to scoop the garbage into the compartment (10). A garbage compactor cylinder (30) is mounted on each outer side of the compactor (20). A compactor shaft (32) is secured between the garbage compactor piston rods (31) in the garbage compactor cylinders (30) and extends through the compactor (20). A slot (21) is defined in each side of the compactor (20), and the compactor shaft (32) extends through the slots (21). A scoop shield (33) is pivotally mounted on the compactor shaft (32). Two scoop cylinders (40) are pivotally mounted on the compactor shaft (32) respectively on opposite sides of the shield (33). The garbage scoop (34) is pivotally attached to the shield (33). The scoop piston rod (42) of each scoop cylinder (40) is pivotally connected to the scoop (42).

When the garbage compactor cylinders (30) are actuated, the compactor shaft (32) will slide along the slots (21) and the shield (33) and the scoop (34) will move relative to the compactor (20). When the scoop cylinders (40) are actuated, the scoop (34) will pivot relative to the shield (33) to scoop the garbage. Consequently, the garbage put in the compactor (20) can be scooped into the compartment (10) through the operations of the garbage compactor cylinders (30) and the cylinders (40).

A lock device (50) is arranged between the garbage compactor (20) and the garbage compartment (10) to lock the garbage compactor (20) onto the garbage compartment (10). The lock device (50) substantially comprises a lock cylinder (51), a connecting bar (53), a linkage (not numbered) and a hook (55). One end of the connecting bar (53) is connected to the lock piston rod (52) of the lock cylinder (51). The linkage is connected to the other end of the connecting bar (53). The hook (55) is pivotally mounted on the compactor (20) and connected to the linkage. The hook (55) engages with the post (54) mounted on the compartment (10). This can securely hold the compactor (20) on the compartment (10).

A tailgate actuator (60) is arranged between the garbage compartment (10) and the garbage compactor (20). The tailgate actuator (60) has a tailgate actuator cylinder (61) pivotally attached to the compactor (20). The tailgate actuator cylinder (61) has a tailgate actuator piston rod (62) pivotally connected to the compartment (10). When the lock device (50) is released and the tailgate actuator piston rod (62) of the tailgate actuator cylinder (61) extends outward, the compactor (20) will rotate relative to the compartment (10) to open the compartment (10). Consequently, the garbage in the compartment (10) can be dumped out.

A dumping actuator (70) is mounted in the compartment (10) to push the garbage out of the compartment (10). The dumping actuator (70) has a dumping actuator cylinder (71), a link (73) and a pressing plate (74). The dumping actuator cylinder (71) is pivotally mounted in the compartment (10) and has a dumping actuator piston rod (72). The link (73) is pivotally connected to the dumping actuator piston rod (72). The pressing plate (74) is moveably mounted in the compartment (10) and pivotally connected to the link (73).

When the garbage is scooped into the compartment (10) with the garbage scoop (34), the pressing plate (74) can block the garbage such that the garbage is compacted by the scoop (34) and the pressing plate (74). When the garbage is dumped out of the compartment (10), the pressing plate (74) is driven by the dumping actuator cylinder (71) and the link (73) to push the garbage out of the compartment (10).

In addition, a trailer hitch assembly (75) is always mounted on the garbage compactor (20) to connect a trailer (not shown) behind the garbage truck. The trailer hitch assembly (75) has a trailer hitch cylinder (76) and a trailer hitch (not shown). The trailer hitch cylinder (76) is mounted on the compactor (20) and has a trailer hitch piston rod (77). The coupler is connected to and actuated by the piston rod (77) to connect the trailer.

However, because there is no monitoring and control station on the garbage truck, the user cannot know immediately when or where there is damage. It is difficult to find a damaged device from the garbage truck, and the user must check the whole garbage truck to find the damaged device. Consequently, to repair the damaged device is very troublesome. In addition, because the user cannot immediately find a damaged device and what damaged device cannot work, overload of a motor or a compressor for applying hydraulic pressure or compressed air to the cylinders (30, 40, 51, 61, 71, 76) easily occurs.

To overcome the shortcomings, the present invention tends to provide a monitoring and control station to mitigate or obviate the aforementioned problems.

### SUMMARY OF THE INVENTION

The main objective of the invention is to provide a monitoring and control station to detect and show the motions of the cylinders on the garbage truck. The monitoring and control station has a panel, multiple switches, multiple monitoring units and multiple sensors. The multiple switches are mounted on the panel and each connected to one of the cylinders on the garbage truck. The monitoring units are mounted on the panel, and each monitoring unit electrically connects with at least one sensor. Each sensor is mounted on the garbage truck and corresponds to one of the cylinders on the garbage truck. Accordingly, the motion of the piston rod of each cylinder on the garbage truck is detected and shown. The user can find where a damaged device is immediately. To repair the damaged device on the garbage truck is simplified.

Other objects, advantages and novel features of the invention will become more apparent from the following detailed description when taken in conjunction with the accompanying drawings.

### BRIEF DESCRIPTION OF THE DRAWINGS

FIG. 1 is a top plan view of a monitoring and control station in accordance with the present invention;

FIG. 2 is a partial side plan view of a garbage truck in accordance with the prior art;

FIG. 3 is a perspective view of a garbage compactor on the garbage truck in FIG. 2; and

FIGS. 4A to 4D are operational side plan views of a garbage scoop on the garbage truck in FIG. 2.

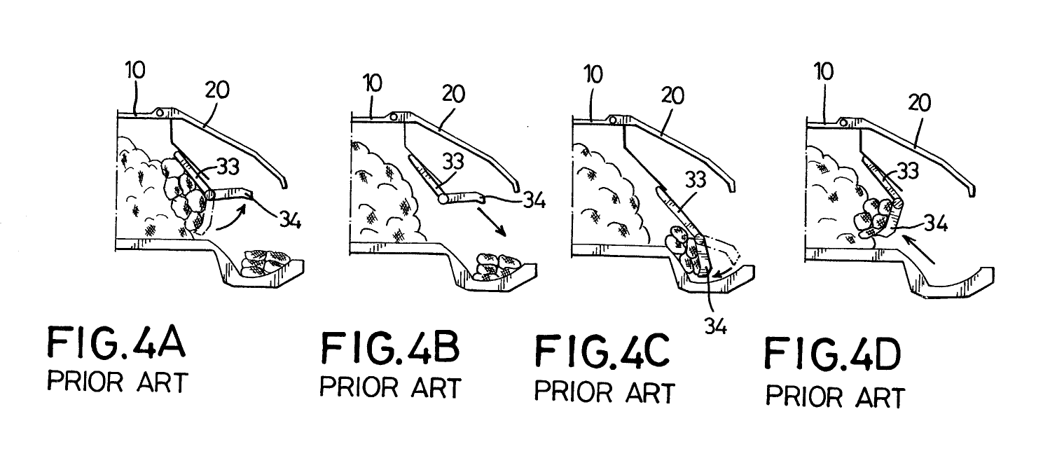

### DETAILED DESCRIPTION OF PREFERRED EMBODIMENT

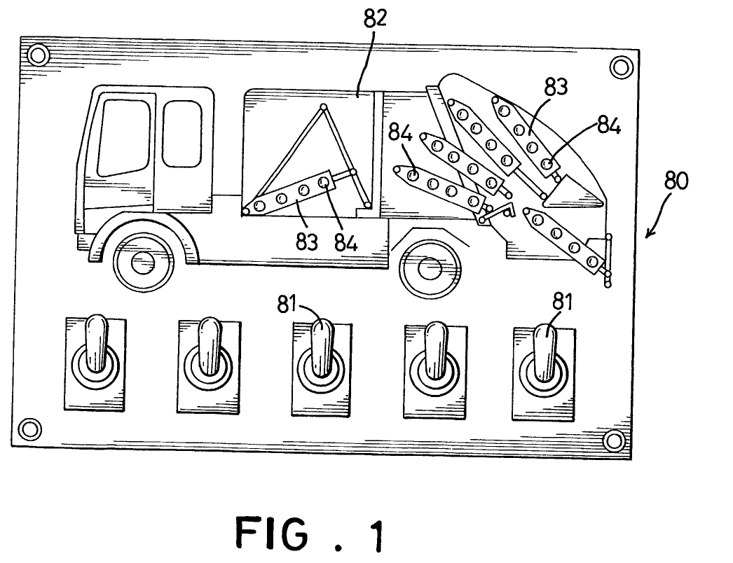

With reference to FIG. 1, a monitoring and control station in accordance with the present invention comprises a panel (80), multiple switches (81), multiple monitoring units (83) and multiple sensors (not shown). The monitoring and control station is mounted on a garbage truck, specifically, on the dashboard in the garbage truck. Consequently, the driver can use the monitoring and control station when he or she is in his or her seat.

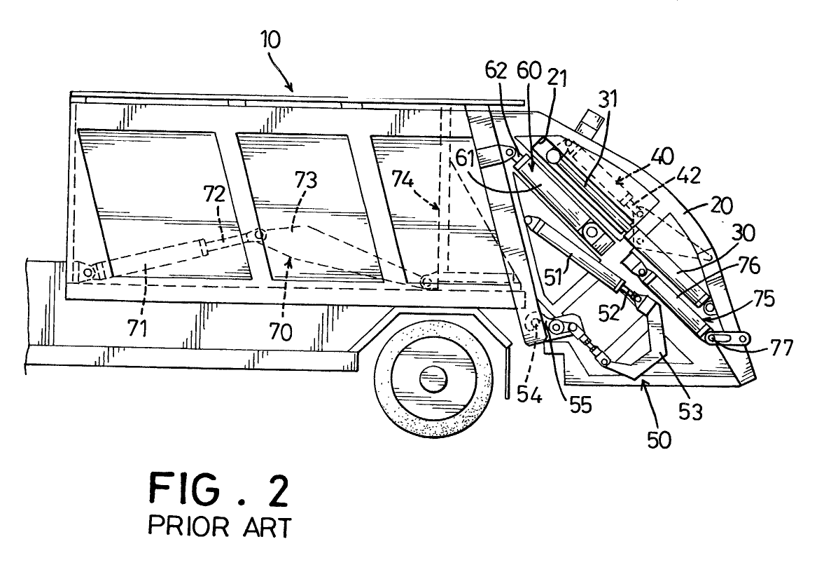

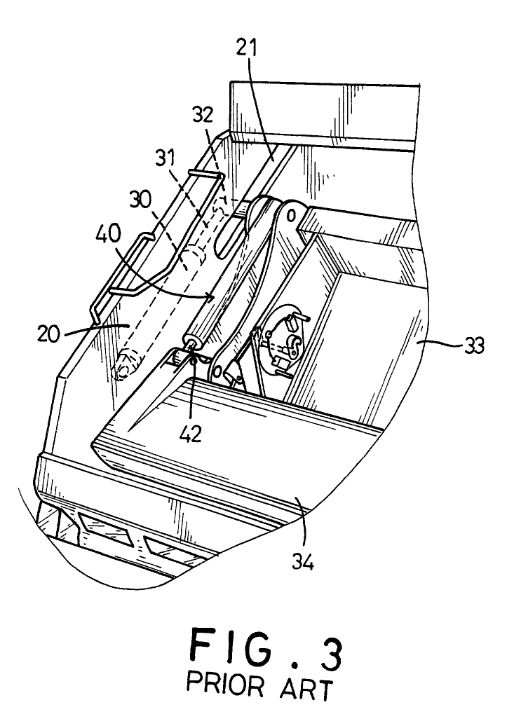

With reference to FIGS. 2 and 3, the monitoring and control station is used to detect and show the motions of the elements of the garbage truck like a garbage scoop (34), a lock device (50), a tailgate actuator (60), a dumping actuator (70) or a trailer hitch assembly (75) described in the description of the related art.

The switches (81) are mounted on the panel (80), and each is connected to one of the cylinders (30, 40, 51, 61, 71, 76) on the garbage truck to control the operation of the corresponding device.

The monitoring units (83) are mounted on the panel (80). Each monitoring unit (83) has multiple lights (84) arranged in a row. Each light (84) can be a light bulb or a light emitting diode (LED). Each light (84) is electrically connected to one of the sensors. In practice, an indicating area (82) is arranged on the panel (80) and has a configuration of a garbage truck. The monitoring units (83) are arranged in the indicating area (82). Each monitoring unit (83) is located at a position in the indicating area (82) which corresponds to one of the cylinders (30, 40, 51, 61, 71, 76) on the truck. Consequently, each monitoring unit (83) indicates a cylinder (30, 40, 51, 61, 71, 76) on the garbage truck.

The sensors are mounted on the garbage truck. At least one sensors corresponds to each cylinder (30, 40, 51, 61, 71, 76) on the garbage truck to detect the motion of the piston rod (31, 41, 52, 62, 72, 77) of the corresponding cylinder (30, 40, 51, 61, 71, 76). In practice, the sensors corresponding to a same cylinder (30, 40, 51, 61, 71, 76) are arranged in a row along the travel of the piston rod (31, 41, 52, 62, 72, 77) of the cylinder (30, 40, 51, 61, 71, 76).

In use, with reference FIGS. 1 and 2, the user can actuate or stop the device on the garbage truck by means of turning on or off the corresponding switch (81) on the panel (80). When one of the devices of the garbage truck is in operation, for example the garbage compactor cylinder (30) of the garbage scoop (34), the sensors corresponding to the garbage compactor cylinder (30) will detect the motion of the garbage compactor piston rod (31) of the garbage compactor cylinder (30) as the garbage compactor piston rod (31) passes through or touches the corresponding sensor. The lights connected to the sensors corresponding to the garbage compactor cylinder (30) will light to show the motion of the garbage compactor piston rod (31). The user can watch the motion of the garbage compactor cylinder (30) in the driver's seat.

When one of the devices is damaged and does not work, the piston rod (31, 41, 52, 62, 72, 77) of the cylinder (30, 40, 51, 61, 71, 76) in the damaged device cannot move to a desired position. The sensor corresponding to the cylinder (30, 40, 51, 61, 71, 76) of the damaged device cannot detect the travel of the piston rod (31, 41, 52, 62, 72, 77), and the corresponding light (83) will not light or light the desired light. The user can immediately find that there is something wrong with that device and turn off the corresponding switch (81) on the panel (80). The overload of the motor or the compressor applying pressure to the cylinder (30, 40, 51, 61, 71, 76) can be avoided. The user can check and repair the damaged device directly rather than have to check the whole garbage truck. To repair the damaged device in the garbage truck is simplified and efficient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A central monitoring and control station for a garbage truck having a garbage compartment, a garbage compactor to close the garbage compartment, a garbage scoop pivotally arranged in the garbage compactor and having a garbage compactor cylinder with a garbage compactor piston rod to move the garbage scoop relative to the compactor and a scoop cylinder with a scoop piston rod to pivot the scoop, a lock device having a hook engaging with the compartment and having a lock cylinder with a lock piston rod to rotate the hook, a tailgate actuator mounted on the compactor and having a tailgate actuator cylinder with a tailgate actuator piston rod pivotally connected to the compartment and a dumping actuator mounted in the compartment and having a dumping actuator cylinder with a dumping actuator piston rod, a link pivotally connected to the dumping actuator piston rod of the dumping actuator cylinder and a pressing plate pivotally connected to the link and moveable mounted in the compartment, the monitoring and control station comprising:
a panel;
multiple switches mounted on the panel and each adapted to be connected to one of the cylinders on the garbage truck;
multiple monitoring units mounted on the panel;
at least one sensor electrically connected to each monitoring unit and adapted to correspond to one of the cylinders on the garbage truck to detect the position of the piston rod of the corresponding cylinder.

2. The central monitoring and control station as claimed in claim 1 further comprising a second monitoring unit mounted on the panel; and
at least one second sensor electrically connected to the second monitoring unit and adapted to correspond to a trailer hitch assembly for connecting a trailer to the garbage truck.

3. The central monitoring and control station as claimed in claim 2 further comprising an indicating area arranged on the panel and having a configuration as a garbage truck,
wherein the monitoring units are mounted in the indicating area; and
each monitoring unit is located at a position in the indicating area adapted to correspond to one of the cylinders to which the at least one sensor connected to the monitoring unit corresponds.

4. The central monitoring and control station as claimed in claim 3, wherein each monitoring unit has a light electrically connected to each of the at least one sensor and adapted to show the position of the piston rod of the corresponding cylinder.

5. The central monitoring and control station as claimed in claim 1, wherein each monitoring unit has a light electrically connected to each of the at least one sensor and adapted to show the position of the piston rod of the corresponding cylinder.
